(19) United States
(12) Patent Application Publication
(10) Pub. No.: US 2005/0257216 A1
(43) Pub. Date: Nov. 17, 2005

(54) Method and apparatus for facilitating deployment of software applications with minimum system downtime

(76) Inventors: David Cornell, Epping (AU); Lars Feldmann, Sydney (AU); Alexander Afanasjev, Sydney (AU); Evgueni Dimitrov, Randwick (AU)

Correspondence Address: UNISYS CORPORATION, UNISYS WAY, MAILSTOP E8-114, BLUE BELL, PA, 19424-0001, US

(21) Appl. No.: 10/490,765

(22) PCT Filed: Sep. 10, 2001
(86) PCT No.: PCT/AU01/01134

§ 371 Date: Mar. 21, 2005

(51) Int. Cl. G06F 9/445

(52) U.S. Cl. 717/177

(57) ABSTRACT

The present invention relates to an apparatus and method for facilitating deployment of a software application with minimum down time, and in particular, to an apparatus and method which enables a deployed software application to operate before completion of data migration. In response to a date call it is determined whether the data exists in the existing persistence or the new persistence, and if the data exists in the existing persistence, migrating the data to the new persistence and providing the data for operation of the application.

### FIELD OF THE INVENTION

The present invention relates to an apparatus and method for facilitating deployment of a software application with minimum system downtime, and in particular, to an apparatus and method which enables a deployed software application to operate before completion of data migration.

### BACKGROUND OF THE INVENTION

Software applications require data to operate and the data is often stored in a database. This is particularly the case for Enterprise-type software applications.

Computerised databases are well known, and many methods of storing data within databases and retrieving data from databases are also well known.

However, as the needs of organisations change, so the software application that the organisations use need to be changed for the purposes of better more efficient operation or for dealing with further data. Where a change in an application results in a change in the data utilised by that application or organisation of the data utilised by that application, then updating of the database at least insofar as it is affected by the changed application, needs to take place. Further, an organisation's database may require updating to incorporate new information required by the organisation, and new software applications may need to be written in order to perform processes on the new data.

When a software application is upgraded resulting in a change in the database schema, or when a database change is made (resulting in a software application upgrade in order to allow an application access to the changed database) the organisation faces two tasks. The first is to deploy the new software application onto the relevant system the “system” being appropriate hardware and software utilised by the organisation). The second task is to migrate the data from the existing persistence to the new persistence (data migration).

Commonly, a database consists of two parts. One part comprises the raw data that is stored within the database. The other part, termed the “schema”, is a framework that stores relevant information describing the physical location of the raw data within the database. In other words, the schema is analogous to a map, directing a database access application to the correct physical location of the raw data within the database.

Whenever a new field is added to the database, or the type of an existing field is changed within the database (at least insofar as it relates to the updated part), both the schema and the raw data must be updated to reflect this change. This data migration process can be very time consuming. Under existing methodologies, a script (a small application which maps or converts data from a first schema to a second schema) is coded and deployed to update the schema and the physical location of the raw data. If a database has millions of separate entries, data migration using this existing methodology may take several hours or days.

During this time, the database may not be accessed by users, because at any given time interval during the data migration process, the relative physical location of a subset of data is unknown. Hence, the database may only be accessed when data migration is complete; ie. when both the second schema and the placement of the raw data in its new location are complete.

The time consuming aspect of this process poses a dilemma for organisations. Many organisations rely on the successful operation of software applications and databases for their daily transactions. The time and cost involved in data migration creates an environment where upgrades to the database and its supporting database access applications are avoided. This results in organisations continuing to use applications and databases that are slow, cumbersome, and increasingly irrelevant to their needs.

One reason for the complexity (and associated time required for data migration) involved in an upgrade of an application or database, apart from the physical size of the database, is the complex nature of certain relationships between different subsets of data within the database. For example, in relational databases, one subset of data may include a field that is simply a “pointer” to another subset of data. This subsequent subset of data is termed a “relation”. When one set of data is moved, all the related subsets of data must also be moved, or the “pointer” in the original set of data becomes meaningless. This is one reason why it is difficult to migrate data whilst the database access application is running.

In view of the problems faced in updating and maintaining databases and database access applications, many organisations employ quick fixes, attempting to re-code database access applications that conform to and work within an existing database schema. It is apparent that such a strategy is not optimal.

There is a need for a solution which enables an application upgrade to be made to a system whilst facilitating minimum downtime of the system. The less downtime that an organisation experiences for application upgrades, the more likely they are to implement upgrades and therefore maintain their system in an optimal state of operation.

### SUMMARY OF THE INVENTION

In accordance with a first aspect, the present invention provides a method of operating a computing system which facilitates operation of an application during data migration from an existing persistence to a new persistence, the method comprising the steps of, in response to a data call required for operation of the application, determining whether the data exists in the existing persistence or the new persistence, and, if the data exists in the existing persistence, migrating the data to the new persistence and providing the data for operation of the application.

It will be understood that the data access call may be performed before, after or during the process of data migration.

The term “persistence” indicates a particular implementation of a database schema.

The computing system may include any hardware and software appropriate for a particular organisation's needs. The system may be a networked system, or a stand-alone computing system or may generally have any system architecture. In a preferred embodiment, the computing system may include a server computer arranged to serve applications to client computing systems.

The application may be any application arranged to run on the computing system and may be a software application. In a preferred embodiment, the software application is implemented in object-oriented form.

As discussed above, in the prior art, data migration must occur before a new application can be utilised. This leads to significant downtime of a system. Implementing the present method, enables an application to be utilised without data migration having occurred. Data migration may occur “piecemeal” as the application (or applications if more than one application is upgraded at the same time) requires the data.

Preferably, however, the method comprises the further step of migrating data independent of any operation of the application. This “background” migration of data may occur at convenient times for the system, e.g. in the evening or at weekends. If the system loading allows the capacity, however, the background data migration may occur at any time.

Preferably, the step of determining whether the data exists in the existing persistence or the new persistence, includes the step of identifying a data “label” and searching for the label in the respective persistences to determine where the data is.

In some types of component based software, a convenient label may be provided by the software specification. In the present invention, a “label” is defined as a collection of database fields that may already exist within the database. For example, the Enterprise Java Bean (EJB) specification requirements require that each subset of data associated with a component be assigned a unique primary key identifier. This may be used as the label enabling the method to determine whether the data exists in the existing persistence or the new persistence, in one embodiment.

Preferably, the present invention has the advantage that it allows synchronisation between data migration that occurs as a background activity, and data migration that occurs in response to a user (application) initiated data access call.

It would also be advantageous if the method of the present invention could be utilised with relational databases. The problem with relational databases is that separate subsets of data in a relational database may be related to each other. That is, various subsets of data may be dependent on each other. In the present context, a “subset of data” is defined as any discrete unit of data. It may be a single field within a record, a number of fields within a record, or an entire record. Preferably, the method of the present invention includes the further step of allocating object identifier keys to respective subsets of data. Where an application requires a dependent subset of data, therefore, the step of determining whether the relevant data exists in the existing persistence or in the new persistence can be carried out by determining whether the object identifier key exists in the existing persistence or the new persistence and then obtaining the appropriate subset of data. Even if the “pair” set of data has been migrated to the new persistence, therefore, the dependent set of data can still be located by way of the object identifier key, and it is not necessary to migrate all dependent sets of data at the same time.

Preferably, in order to facilitate operation of the method, the present invention is able to determine whether the data it requires exists in the existing persistence or the new persistence. The present invention is preferably aware of the data label and (in a relational database) of the unique object identifier to enable the present invention to locate the required data. Once the data has been migrated, the application preferably only operates with the new persistence. But before the data has been migrated, the application checks for all the data label and unique object identifiers. Preferably, the unique object identifiers are only viewable by an embodiment of the present invention, and are invisible to the database access application.

In accordance with a second aspect of the present invention, there is provided a computing system arranged to facilitate operation of an application during data migration from an existing persistence to a new persistence, the computing system being arranged to determine, in response to a data call required for operation of an application, whether the data exists in the existing persistence or the new persistence and, if the data exists in the existing persistence, to migrate the data to the new persistence and provide the data for operation of the application.

In accordance with a third aspect of the present invention, there is provided a computer program which when loaded onto a computer system causes the computer, in response to a data call required for operation of a computer application, determines whether the data required for operation of an application exists in the existing persistence or new persistence and, if the data exists in the existing persistence, to migrate the data to the new persistence and provide the data for operation of the application.

In accordance with a fourth aspect of the present invention, there is provided a computer readable medium storing instructions for controlling a computing system to, in response to a data call required for operation of a computer application, determine whether the data required for operation of the application exists in an existing persistence or a new persistence, and, if the data exists in the existing persistence, to migrate the data to the new persistence and provide the data for operation of the application.

### BRIEF DESCRIPTION OF THE DRAWINGS

Features and advantages of the present invention will become apparent from the following description of an embodiment thereof, by way of example only, with reference to the accompanying drawings, in which;

FIG. 1 is a schematic diagram of a system in accordance with an embodiment of the present invention including claims in accordance with an embodiment of the present invention,

FIG. 2 is diagram depicting a number of time lines, which illustrate operation of an embodiment of the present invention.

FIG. 3 is a diagram further illustrating operation of the embodiment of the present invention.

FIG. 4 is a diagram for illustrating operation of the present invention for a relational database.

### DESCRIPTION OF PREFERRED EMBODIMENT

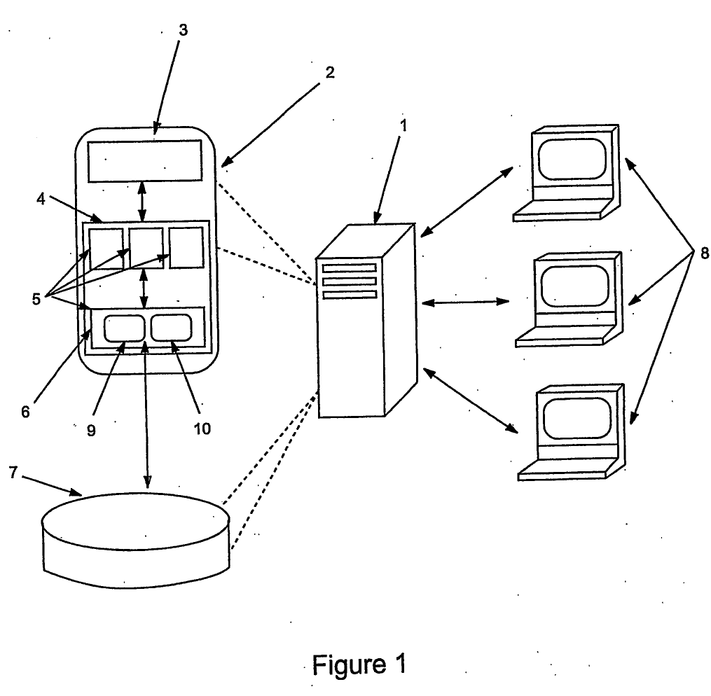

An embodiment of the present invention will now be described with reference to FIG. 1. Referring to FIG. 1, there is shown a server computer 1 which may be connected to several terminals 8. On the server, there is run software application 2, which contains a web server 3, and an EJB container 4, arranged to work in conjunction with the web server and a database 7. In the EJB container, there are a number of EJB components 5, including a data migration EJB component 6, which performs the data migration functions of the present invention. The data migration EJB component 6, is comprised of a determination means 9 which is arranged to determine whether the data exists in the existing persistence or the new persistence. In the present invention, the determination means is implemented as a software module which resides within the data migration EJB component 6. The data migration EJB also comprises an allocation means 10 arranged to allocate object identifier keys to subsets of data which relational dependencies to each other. In the present invention the location means 10 is implemented as a software module within the data migration EJB component 6.

This embodiment of the present invention relates broadly to a deployment process and system for applications requiring access to data in a database. The deployment process is in two parts.

In the first part, an updated database access application is deployed to an application server 1, and the updated database access application replaces an old database access application.

It will be understood that an application server is any type of computer system arranged to allow a user to interact with the database access application. The application server could take the form of a stand-alone computer, or a computer arranged to allow access to the database access application from a remote terminal or remote terminals 8, over any type of network, such as an internal proprietary network, or the Internet. Moreover, the network may use any protocol or transmission medium, and could be fixed wire or wireless.

In addition, it is to be understood that the database 7 could reside on a separate machine, or may reside on the same machine as the application server. All of these variations fall within the scope of the invention.

During the time when the old database access application is unloaded and the new database access application is loaded, the system is “down” ie. a user cannot access the database access application or the database.

In the second step, data migration occurs in the background while runtime access is concurrently allowed to the database access application and the database. In the present embodiment, the invention is implemented as an Enterprise Java Bean (EJB) component 6, designed to work within an EJB container 4 on an application server 1.

In the present invention, the application server may be understood to mean an EJB container on its own, or an EJB container associated with a web server 3. That is, a server capable of serving HTML pages, XML pages, ASP (Active Server Pages), or any other type of “web” readable formats which can be understood and interpreted by a browser such as Netscape Navigator™ or Microsoft Internet Explorer™ or any other suitable Internet browser application.

In such an environment, the EJB container will be understood to be a “middleware” application, providing an interface and working as a translator between a database and the web server or any other application that transforms raw data into a presentable format. The EJB container, in association with web server technology, allows a user to interact with a database (eg. view and change database entries) via the Internet, using only Internet browser technology.

The EJB component 5 will be understood to be a component which resides in the EJB container 4. The EJB component implements certain database access calls or functions. For example, let us assume that the database in question is an “ordering” database. It holds, amongst other information, the past and present orders of every client. In such an environment, the EJB component may consist of a series of database calls (including the data structures) which are necessary to manipulate the data within an ordering database. Therefore, the EJB component may include, for example, a routine to create a new order, a routine to find an order, a routine to delete an order, a routine to amend an order, etc.

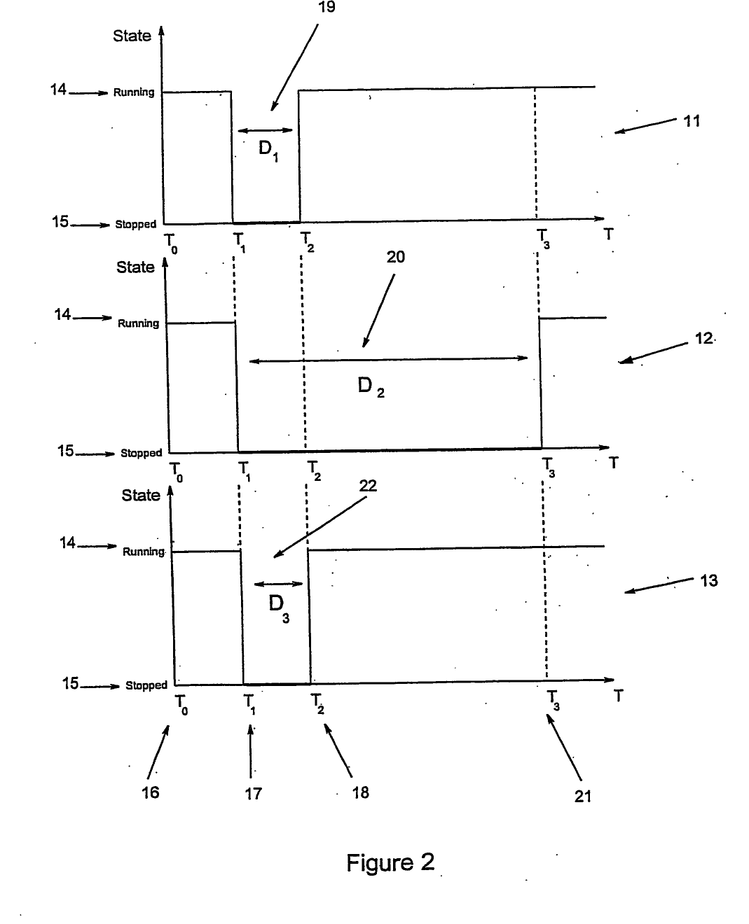

The data migration process is illustrated in FIG. 2, which shows a series of three time lines, labelled 11, 12 and 13. Each time line depicts two states on its vertical axis, “running” 14 and “stopped” 15. The horizontal axis depicts the progress of time, in arbitrary units. At time To 16 on all time lines, it is assumed that the database access application and the database are in the “running” state. At time T₁ 17 a new database access application is deployed to the application server. At the point T₁, both the database access application and the database must be “stopped” ie. access by a user is no longer allowed to the database access application or the database. From time T₁ 17 onwards, the old database access application is unloaded, and the new database access application loaded into the application server.

At time T₂ 18 the new database access application has been successfully deployed and the database access application returns to the “running” state as depicted on time line 11. Therefore, the time interval for deploying the new database access application is the time interval D₁ 19. In a conventional database access application/database arrangement, data migration is also required, and usually takes much longer to complete than the database access application deployment. This interval is shown on time line 12 as time interval D₂ 26. Database migration, as noted in time line 12, begins at the same time T₁ 1). The database migration process stretches from time T₁ 17 to time T₃ 21. Therefore it is apparent that conventional technologies require a “down time” equivalent to the interval D₂ 20 which is generally much greater than that required by the present invention.

The present invention allows concurrent data migration, as shown in time line 13 using the data migration EJB component referred to in FIG. 1. Therefore, the only “down time” required for the present invention is the down time in deploying the new database access application, namely the interval from T₁ 17 to T₂ 18. The total down time for the present invention is given by interval D₃ (22) and is equivalent to the down time for deploying the database access application D₁ 19.

The programmer creating the EJB component does not need to be aware of the details or structure of the database, but rather, uses this embodiment of the present invention as an intermediate piece of software. The programmer writes. his database access calls, and deploys them as part of an EJB component to the EJB container. The data migration EJB component 6, in accordance with an embodiment of the present invention, includes a determination means which comprises instructions that enable the data migration EJB 6 to determine whether data required for operation of the application is located in an existing persistence or a new persistence. The instructions may comprise the steps of applying a data “rule” to the query for data, thus searching for the data in the existing persistence, but satisfying the rule for the new persistence. For example, if we assume that all data elements “a” were to be migrated from their value “a” to the value “a+1”, then when querying for data value “a”, the rule “a+1” would be applied, thereby allowing the application to access the data in the existing persistence, but satisfying the new query. Relevant subsets of data can therefore be accessed, regardless of the persistence they are present in.

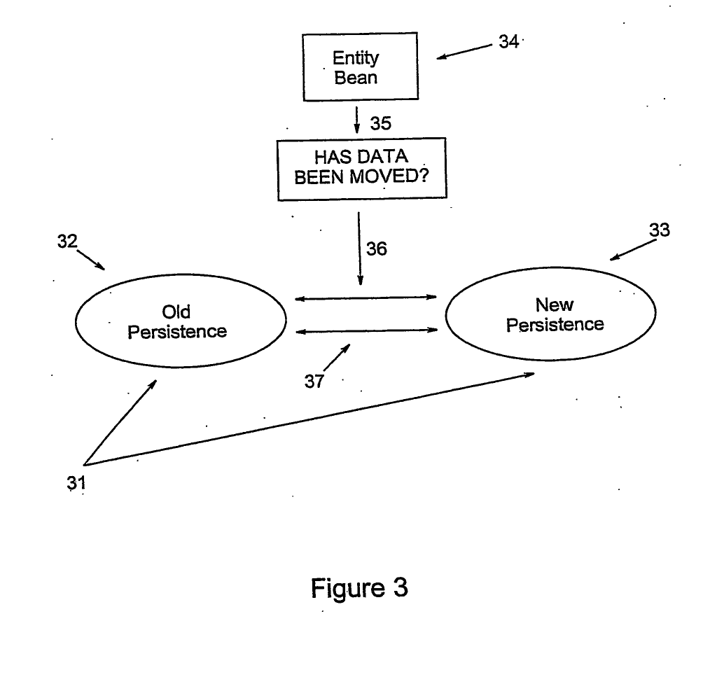

The present invention allows concurrent data migration through two processes as illustrated in FIG. 3.

The two clouds 31 in FIG. 2 represent the database data within the existing persistence 32 and the new persistence 33.

For database access applications 34 (“entity beans”) which are performing data access during data migration indicated by arrow 35, a check 36 is made of the location of the data. If the data is still residing in the existing persistence 32 it is moved to the new persistence 33, and the data access calls are then made on the data in the new persistence 33.

For example, if the user of the database wishes to find a particular customer order (e.g. to find all outstanding orders), the user interacts with the web server (ie. the EJB container 4 and any other appropriate applications). The appropriate EJB component within the EJB container at first instance accesses the existing persistence to check for the location of the order data. If it discovers the relevant data in the existing persistence, the data is. migrated to the new persistence, and then data is retrieved and operated on as required.

For example, in the case of an ordering database, the user may wish to amend a particular customer order, say an order placed for a client called John Smith. Let us assume the quantity of an item needs to be changed. Once the user makes the appropriate data access call, the database migration and access method searches in the existing persistence 32 for any records for John Smith. Having found the appropriate subset of data, the database access and migration apparatus would move the subset of data from the existing persistence 32 to the new persistence 33. Once the subset of data has been moved the new persistence 33, then the subset of data is amended to reflect the new order quantity.

Independent of data migration 35 (in response to an access request on the data), background data migration occurs, as indicated by data migration arrow 37 in FIG. 3.

Synchronisation is provided between the two data migration processes 35 and 37 by the process illustrated in Figure 3. Synchronisation will be understood in the context of the present invention to be a process where background data migration 37 and data migration 35 are aware of each other to avoid data which has already been migrated from being inadvertently re-migrated by either of the aforementioned data migration processes.

There is provided a mechanism by which data is migrated independently of any user calls to the database. The method by which the data is migrated independently of any user calls may be any appropriate method. It could be a sequential migration of subsets of data, a random migration of subsets of data, or any other method.

The preferred mechanism of determining data location is as follows.

Each subset of data within the set of data that comprises the database has a label which enables it to be identified. It will be understood that the label is not the only method available for searching the subsets of data. In the preferred embodiment the label is the primary key provided through the EJB 2.0 Specification requirements[Enterprise Java Beans™ Specification, Version 2.0 available for download at http://java.sun.com/products/ejb/docs.html]. The aforementioned specification requires each subset of data to have a unique key. The uniqueness of the key is maintained within the database. In accordance with the present invention, therefore, the EJB component will “know” when a subset of data has been migrated from the existing persistence to the new persistence. In other words, when a subset of data is migrated the key is carried with the subset of data. Therefore, the EJB component can determine whether a subset of data already resides in the new persistence by checking for a particular primary key within the new persistence.

If the primary key already exists within the new persistence, then the EJB component does not need to check whether the data exists in the existing persistence.

If no matching primary key is found in the new persistence, the EJB component searches the first persistence, find the appropriate subset of data, migrates the data to the second persistence, and then performs the required access call or calls.

As discussed above, in a relational database, a subset of data may include pointers (ie. address values) to other sets of data. In other words, some subsets of data are related objects, as they are linked to other subsets of data.

In complex relational databases, it is apparent from the description above that relations may be multi-layered, and/or recursive. For example, a single subset of data may have a number of links to other subsets of data, which in turn may have a number of links to other subsets of data, and so on. Thus, a subset of data may potentially have thousands of relations. If data migration were to occur concurrently, whilst users were interacting with the database access application and the database, moving all a subset of data and all its relations together could cause an unacceptable degradation in database performance. In the present invention, this potential problem is overcome, as there is no need to migrate all relations with the parent subset of data. This is achieved by making each related object an independent object. The transition of related objects to independent objects is achieved by ascribing an object identifier key to each subset of data. This object identifier key does not change between migration, and is completely separate to the primary key described earlier. The object identifier key never changes, whereas the primary key may change during migration.

This allows related objects to be moved either when they are required (due to an access call by a user), or as part of the background data migration process at a later stage. This provides the advantage that the waiting time a user experiences between a request and a response is minimised, since the EJB component is only required to migrate the relevant subset of data, and not all of the related subsets of data.

For example, in the example given so far, it is quite possible that the ordering database could be ordered as a series of subsets of data which contain a number of fields to retain information about a customer or client, and in addition, a number of pointers or links to completely independent orders. Therefore, any given subset of data which holds customer details may also contain many pointers to subsets of data which contain order details. In turn, these order details may contain recursive pointers to the subsets of data which hold customer details, as well as other pointers to, for example, price lists, current stock on hand, etc.

Thus, as can be seen in this example, if a user is simply interested in accessing a list of customers, it would cause a large time penalty if all the associated subsets of data were also migrated.

Therefore, in the present invention, the customer subsets of data would be migrated from the first schema to the second schema. As each subset of data was migrated, each dependency originating from the subset of data would be assigned a unique object identifier key, corresponding to the subset of data that was migrated.

If we assume that the database consisted of 2000 customers, each with an average of 1000 orders per customer. If all dependencies were moved when the customer subsets of data were moved, then the user would have to wait for 2,000,000 records to be moved. However, with the present invention, only 2000 records would have to be moved.

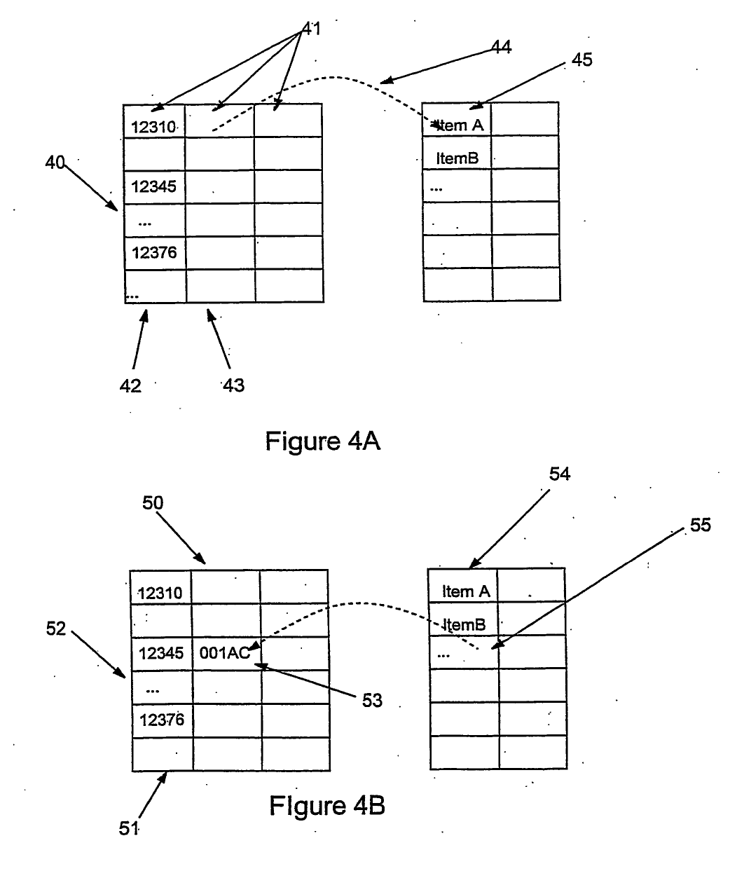

The invention is now described by way of specific example as shown in FIGS. 4A and 4B.

FIG. 4A represents a simple data structure 40 which comprises a number of records 41. In this example, customer record 42 contains a list of customer orders. A corresponding record 43 contains a relation 44 to an order record 45. In the present example, a relation will be understood to mean a link between separate records. This link may be achieved by any known method. For example, the link may be established by holding the address value of the corresponding ordered record 45. Within the order record 45, are stored values of items purchased for that particular order.

This simple data structure 40, is implemented as a persistence. A persistence, in the context of the present invention, may be understood to be the physical implementation of the abstract data structure shown in FIG. 4A.

This persistence, as shown in FIG. 4B, takes the form of a table 50. Therefore, the order record shown in FIG. 4A finds it practical implementation as a table of OrderNumbers 51. An individual OrderNumber 52 has a corresponding object identifier 53, which allows the OrderNumber to be uniquely identified by the present invention. In accordance with the abstract data structure shown in FIG. 4A, there is also provided a corresponding line item table 54, which contains a row of values 55, being reference value 55 to the table of OrderNumbers 52. The reference, is the practical implementation of the link described in the proceeding paragraphs. In other words, the reference represents the link between the table of order values and the table of line items. In the present example, an order is uniquely identified by an OrderNumber which is a five character string (eg. “12345”).

The order is produced and used by the database access application, for the purpose of keeping track of customer orders. The object identifier is produced and used by the persistence layer and is invisible to the application. The present invention may be termed a persistence layer, since it is implemented as an EBJ component which sits “on top” of the persistence as a “layer”. In other words, the present invention is a persistence layer which comprises the determination means and the allocation means and provides a “buffer” between the database access application and the persistence (ie. practical implementation of the data of the database). The reference value 55 held in one of the rows of the line item table 54 is used as a link to the table 50. As the reference value 56 is required to refer back to the corresponding order values, it may be based on either an OrderNumber 52 or an object identifier 53. However, using the address value of the OrderNumber causes complications—if the application wishes to change the OrderNumber 52 this will affect both tables. Therefore, the relation between the two values is expressed by the object identifier 53 which is entirely under the control of the persistence layer and is not effected by application requirements.

In the present example, after a period of time the number of orders became so large that it was decided to implement the value OrderNumber as a seven character string instead of a five character string. This required a change in the data access application and a change in the data structure. In other words, it is necessary to convert old values into new values by prepending two zeros to them. For example, “12345” will become “0012345”.

In accordance with an embodiment of the present invention, this is achieved in the following manner.

Firstly, the persistence layer receives a request from the program to concatenate “00” with the corresponding strings in the OrderNumber column.

Secondly, the persistence layer begins moving rows from TableOrder to TableOrderNew (this is the background migration process) concurrently applying the rule “00” ∥ OrderNumber, where ∥ indicates that the string “00” should be appended to the string in “OrderNumber”.

Thirdly, when the database access application calls the persistence layer asking for access to row, the persistence layer ensures first that this is row in TableOrder new. For example, if the application asks for a row with OrderNumber “0012345”, the persistence layer looks in the TableOrder for:

TableOrderTableOrderSELECT FROM TableOrder WHERE “00” ∥ OrderNumber equals “0012345”

If a row is found satisfying a condition, it is moved to TableorderNew with “00” added in the beginning of OrderNumber pre-emptive migration and then made available to the application.

The behaviour of the persistence layer takes place only while there exist rows in TableOrder. When TableOrder becomes empty the persistence layer ceases to apply the rule.

It would be appreciated by persons skilled in the art that numerous variations and/or modification may be made to the invention as shown in the specific embodiments without. departing from the spirit or scope of the invention as broadly described. The present embodiments, therefore, are to be considered to in all respects illustrative and not restrictive.

1. A method of operating a computing system which facilitates operation of an application during data migration from an existing persistence to a new persistence, the method comprising the steps of, in response to a data call required for operation of the application, determining whether the data exists in the existing persistence or the new persistence, migrating the data to the new persistence if the data exists in the existing persistence, providing the data for operation of the application, and allocating object identifier keys to respective subsets of data where the subsets of data have relational dependencies to each other, whereby dependent data may be located using the object identifier key without being required to migrate the data with the parent data.

2. A method in accordance with claim 1, comprising the further step of migrating data independent of any operation of the application.

3. A method in accordance with claim 1, wherein the step of determining whether the data exists in the existing persistence or the new persistence, includes the step of identifying a data label and searching for the label in the respective persistences to determine where the data is located.

4. A method in accordance with claim 3, wherein the application is in the form of an Enterprise Java Bean component and the label is the primary key identifier.

5. (canceled)

6. A computing system arranged to facilitate operation of as application during data migration from an existing persistence to a new persistence, the computing system including determination means arranged to determine, in response to a data call required for operation of an application, whether the data exists in the existing persistence or the new persistence, migration means to migrate the data for operation of the application, and allocation means to allocate object identifier keys to respective subsets of data where the subsets of data have relational dependencies to each other, when independent data may be located using the object identifier key without being required to migrate the data with the parent data.

7. A system in accordance with claim 6, wherein the determination means is arranged to identify a data label and searching for the label in the respective persistence to determine where the data is located.

8. A system in accordance with claim 7, wherein the application is in the form of an Enterprise Java Bean component and the label is the primary key identifier.

9. (canceled)

10. A computer program which when loaded onto a computer system causes the computer to, in response to a data call required for operation of a computer application, determine whether the data required for operation of an application exists in the existing persistence or the new persistence, migrate the data to the new persistence if the data exists in the existing persistence, provide the data for operation of the application, and allocate object identifier keys to respective subsets of data where the subsets of data have relational dependencies to each other, whereby dependent data may be located using the object identifier key without being required to migrate the data with the parent data.

11. A computer readable medium storing instructions for controlling a computing system to, in response to a data call required for operation of a computer application, determine whether the data required for operation of the application exists in an existing persistence or a new persistence, migrate the data to the new persistence if the data exists in the existing persistence, provide the data for operation of the application and allocate object identifier keys to respective subsets of data where the subsets of data have relational dependencies to each other, whereby dependent data may be located using the object identifier key without being required to migrate the data with the parent data.

12. A method of operating a computing system which facilitates operation of an application during data migration from an existing persistence to a new persistence, the method comprising the steps of, in response to a data call required for operation of the application, determining whether the data exists in the existing persistence or the new persistence, the determining step including the step of identifying a data label and searching for the label in the respective persistences to determine where the data is located, and, if the data exists in the existing persistence, migrating the data to the new persistence and providing the date for operation of the application

13. A method in accordance with claim 12, wherein the application is in the form of an Enterprise Java Bean component and the label is the Primary key identifier.

14. A computing system arranged to facilitate operation of an application during data migration from an existing persistence to a new persistence, the computing system including determination means arranged to determine, in response to a data call required for operation of an application, whether the data exists in the existing persistence or the new persistence, the determination means further arranged to identify a data label and to search for the label in the respective persistence to determine where the data is located and, if the data exists in the existing persistence, to migrate the data for operation of the application.

15. A system in accordance with claim 14, wherein the application is in the form of an Enterprise Java Bean component and the label is the primary key identifier.
